(19) United States
(12) Patent Application Publication
(10) Pub. No.: US 2012/0006332 A1
(43) Pub. Date: Jan. 12, 2012

(54) HEEL SUPPORT DEVICE FOR CIRCULATION IMPROVEMENT

(76) Inventor: William Davis, Lynchburg, VA (US)

(21) Appl. No.: 12/831,723

(22) Filed: Jul. 7, 2010

(51) Int. Cl. A61G 99/00

(52) U.S. Cl. 128/845

(57) ABSTRACT

The crossing of one's legs while sitting often results in sensations of tingling and discomfort and difficulty in returning to an erect position and walking. The underlying causes of these sensations are often associated with serious health conditions due to the potential of loosing balance and falling as well as formation of blood clots in the legs that can lead to premature death. The present invention alleviates the symptomatic affects of sitting with crossed legs by supporting the heels of the user in a position that separates the legs from mutual contact or contact with the surfaces of the invention.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND

The present invention represents a significant step forward in the field of preventive devices promoting health, particularly for seniors who prefer sitting with their legs crossed. Numbness in the legs after prolonged crossed leg sitting is associated with falling and the tingling sensation is associated with reduced circulation that can promote the formation of blood clots. The present invention provides for support of one heel in a comfortable position and supports the heel of the crossed leg at an elevated level where the legs are separated and the remainder of the leg is not contacted by the invention. There are numerous calf supports addressing medical conditions where one or both calves are supported at a single level having non-functional second levels. However, the present invention is uniquely dedicated to positively supporting and horizontal positioning of the heel to provide vertical space between crossed legs, preventing inadvertent leg contact as well as providing height adjustability and convertibility back to use as conventional furniture.

### PRIOR ART

The following is art representative of what is published in the field of rests for the lower extremities.
The patent to Kelly (U.S. Pat. No. 621,098) discloses an apparatus that supports two feet or legs on a cushioned surface has a total length of the apparatus for support of the heels is supported by a floor supported structure with adjusted elevation by mechanical adjustment.
The patent to Kelly (U.S. Pat. No. 621,098) lacks disclosure of an apparatus that supports a top heel and a bottom heel thereby preventing contact between crossed legs and lacks a user sitting with crossed legs and further lacks center lower surface an upper left and right side surfaces and further lacks raised portions on both top cushions to avoid heel sliding and also lacks lower heel positions lying under the top cushioned surfaces, it further lacks support on an existing leg support appliance and further lacks supporting the bottom heel on the appliance as well lacks a top cushion with adjusted elevation by manual exchange of cushions, and further lacks power driven adjustment, and further lacks remotely controlled adjustment and lacks becoming an essentially flat surface when the top cushions are in the retracted position and also lacks control of the slope of the cushioned surfaces.
The patent to Shminisu (US 2003/0006639) discloses an apparatus that supports both legs and is supported on an existing leg support appliance and manually controls the slope of the cushioned surfaces.
The patent to Shminisu (US 2003/0006639) lacks an apparatus that support s a top heel and a bottom heel of a user sitting with crossed legs and lacks center lower surface and an upper left and right side surfaces with raised portions on both top cushions to avoid heel sliding, Shminisu further lacks lower heel positions lying under the top cushioned surfaces, it lacks a total length of the apparatus for support of the heels it further lacks support by a floor supported structure it lacks adjustment elevation by manual exchange of cushions, and further lacks mechanical adjustment, power driven adjustment, remotely controlled adjustment and further lacks an essentially flat surface when the top cushions are in the retracted position.
The patent to Spann (U.S. Pat. No. 3,946,451) discloses an apparatus that supports a top leg of a user with center lower surface an upper left and right side surfaces that is supported by an existing leg support appliance
The patent to Spann (U.S. Pat. No. 3,946,451) lacks an apparatus that supports a bottom heel of a user sitting with crossed legs and lacks an upper left and right side surfaces with raised portions on both top cushions to avoid heel sliding, and also lacks lower heel positions lie under the top cushioned surfaces and further lacks a total length of the apparatus for support of the heels is supported by a floor supported structure and further lacks supporting of the bottom heel on the appliance as well as lacks a top cushion with adjusted elevation by manual exchange of cushions mechanical adjustment, it further lacks power driven adjustment, and lacks remotely controlled adjustment and lacks becoming an essentially flat surface when the top cushions are in the retracted position and finally lacks controlling of the slope of the cushioned surfaces.

None of the above patents or Published patent applications singly or in combination is seen to describe the present invention as claimed.

### BRIEF SUMMARY OF THE INVENTION

The present invention is a device that separates the crossed legs of a sitting or reclining person from mutual contact or contact with the device itself. This is accomplished by support of the user's heels. Generally, the instant invention solves the problem of a tingling, pain or numbness in the lower extremities that can lead to falling when attempting to walk or loss of blood circulation that can result in blood clots. Raised cushioned surfaces on either side of a lower cushioned surface appropriately located to achieve separation and with means to keep the top heel from slipping off of the cushion are among the many features to achieve comfort and prolong the period before serious affects become an issue.

It is a object of the present invention to provide an apparatus that support s a top heel and a bottom heel for comfort of a user sitting or reclining with crossed legs.

An additional object of the present invention is to provide a center cushioned surface for supporting a heel of a bottom leg of the crossed legs as sell as left side and right side cushioned surface for supporting a left and a right heel of the crossed legs.

An additional object of the present invention is to provide raised portion on the left and right side cushioned surfaces for resistance to sliding of the user's heels placing the crossed legs in contact with each other.

A further object of the present invention is to provide a center cushioned surface that allows lower heel to rest in a position under a portion of the left side cushioned surface or the right side cushioned surface for comfort.

A further object of the present invention is to provide an apparatus being sufficient length for support of the heels and not taking up the space of a support apparatus for a full leg or a calf portion of a leg.

A further object of the present invention is to provide a customizable heel support by adjustability of the outer cushioned surfaces.

A further object of the present invention is to provide an apparatus that is supported by a separate leg support appliance where the center cushioned surface is the top surface of the separate leg support appliance.

A further object of the present invention is to provide a heel support that includes a floor supported structure;

A further object of the present invention is to provide a heel support apparatus that includes a height adjustment is made by manual exchange of cushions.

A further object of the present invention is to provide a heel support apparatus that includes a height adjustment is made by mechanical adjustment of cushioned surfaces;

A further object of the present invention is to provide a heel support apparatus that includes a height adjustment that is power driven;

A further object of the present invention is to provide a heel support apparatus that includes a height adjustment that is controlled remotely;

A further object of the present invention is to provide a heel support apparatus that includes a height adjustment that also controls a slope of the cushioned surfaces.

A further object of the present invention is to provide an essentially flat surface when the outer heel support cushions are adjusted into a retracted position.

### BRIEF DESCRIPTION OF THE SEVERAL VIEWS OF THE DRAWING(S)

FIG. 1a: Is a top view showing the principals of the present invention;

FIG. 1b: Is a front view showing the principals of the present invention;

FIG. 1c: Is a side view showing the principals of the present invention;

FIG. 1d: Is a top view of the mechanics of the present invention;

FIG. 1e: Is a front view of the mechanics of the present invention;

FIG. 2: Is a schematic of the electrical components and controls of the present invention;

FIG. 3: Is a block diagram of the method of use of the present invention.

### DETAILED DESCRIPTION OF THE INVENTION

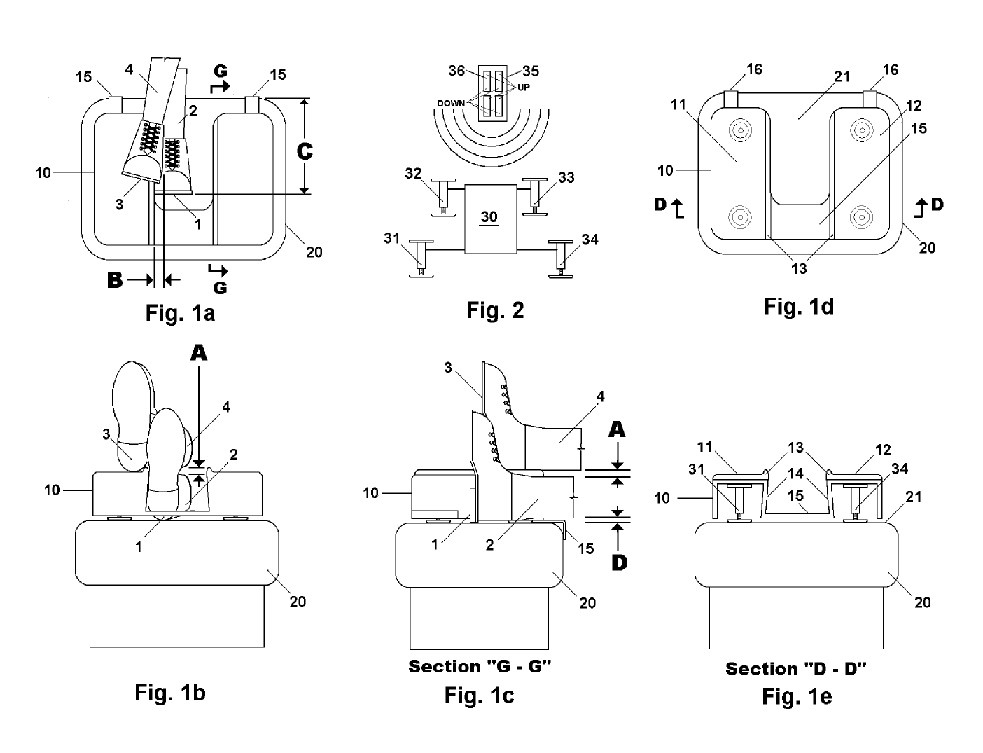

FIG. 1a, 1b and 1c of the present invention 10, supported by a hassock 20, illustrate the six concepts embodied in the present invention, which are:
1. Separate a person's crossed legs 2 and 4 by means of supporting their heels 1 and 3 a small distance labeled (A) at FIGS. 1b and 1c.
2. Provide an easy way to adjust the distance (A) for variations in the size of the user's feet and legs.
3. Position the person's top heel 3 to a horizontal position overlapping their bottom heel 2 shown as distance (B) at FIG. 1a.
4. Prevent a persons top heel from slipping off of the support surfaces 11 or 12 thereby preventing an impact of the person's upper leg onto the person's lower leg;
5. Separate a person's lower leg 2 from support 20 by controlling the position of the lower heel (C) of FIG. 1b which results in a separation between the leg and the leg support by a distance (D).
6. The present invention is shown supported by a hassock at FIG. 1a-1e, for illustration purposes only. It is considered that devices satisfying one or more of the above concepts that are either supported by or built into recliner foot rests, foot stools, ottomans, vehicle seats, aircraft and spacecraft seats, exercise, treatment and therapy equipment or any other foot rest whether for reducing circulation loss or any other purpose are within the spirit of the present invention and therefore within the meets and bounds of the attached set of claims.
FIGS. 1d, 1e and FIG. 2 illustrate how to make the instant invention. The apparatus 10 consists of two elevated heel rest surfaces 11 and 12 and a third heel rest surface 21 that supports the entire apparatus. The elevated surfaces 11 and 12 are cushioned and have a raised portion 13 on the inside edges. Vertical walls 14 extend downward at an incline from the raised edges 13 and end at bridge 15. Raised edges 13 prevent the upper heel 3 from slipping off of the heel support surface 11 which can cause a painful impact with the lower leg 2. Bridge 15 holds heel support surfaces 11 and 12 in the same relative position regardless of any movement of the apparatus 10 with respect to the support 20. Actuators 31-34 can be manually adjusted to raise and loser the entire device or they can be used to tilt the entire device for the user's comfort. Guides 16 contact the edge of the support 20 to properly position the apparatus 10 in the horizontal plane (un-shown).

FIG. 2 shows the apparatus providing easy adjustment of the apparatus to variations in the size of the user by means of actuators 31-34 that extend and contract in length under the control of controller 30. Controller 30 receives wireless, infrared or other signals from a hand held device 35 that has height control switches 36. The controller output conveys appropriate power and or signals to the actuators that cause the actuators to increase or decrease their length thereby adjusting the height of the elevated surfaces.

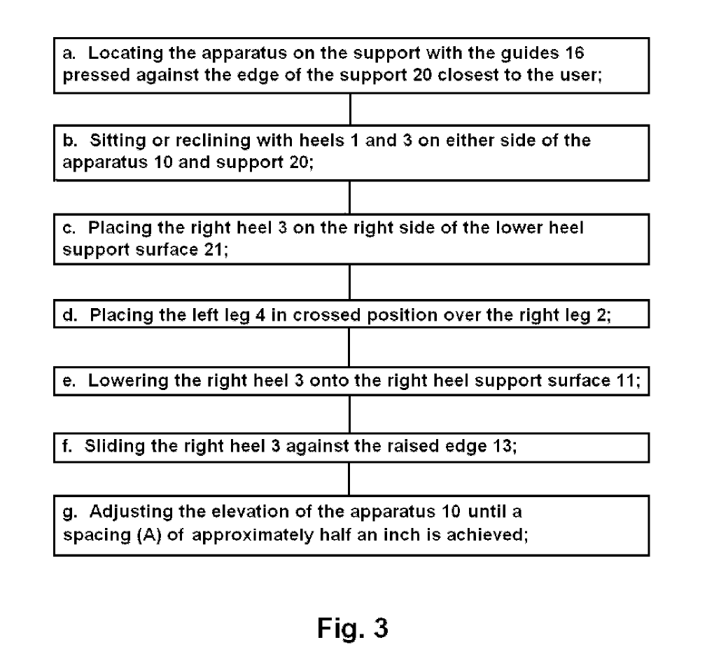

FIG. 3 outlines the steps of using the instant invention.
a. Locating the apparatus on the support with the guides 16 pressed against the edge of the support 20 closest to the user;
b. Sitting or reclining with heels 1 and 3 on either side of the apparatus 10 and support 20;
c. Placing the right heel 3 on the right side of the lower heel support surface 21;
d. Placing the left leg 4 in crossed position over the right leg 2;
e. Lowering the right heel 3 onto the right heel support surface 11;
f. Sliding the right heel 3 against the raised edge 13;
g. Adjusting the elevation of the apparatus 10 by use of the switches 36 on remote control 35 until a spacing (A) of approximately half an inch is achieved;

It is considered that manual, semi-automatic, automatic, local and alternate remote means of adjusting the height of the apparatus that utilize one or more of the concepts of the instant invention are within the spirit of the invention and within the meets and bounds of the attached claims.

Although the terms and definitions used in the specification are intended to be read into the claims they are hot intended to limit the meets and bounds of the claims presented here below in any manner whatsoever.

I claim:

1. An apparatus that supports both heels of a user's crossed legs for preventing contact between the user's crossed legs, comprising:
a floor supported structure;
an essentially horizontal surface of the floor supported structure;
one or more elevated surfaces resting on the floor supported structure;
wherein the one or more elevated surfaces leaves at least part of the essentially horizontal surface of the floor supported structure exposed;
wherein the essentially horizontal surface is cushioned;
wherein the one or more elevated surfaces is cushioned;

2. The apparatus of claim 1, wherein:
the floor supported structure is a furniture for raising a person's legs;

3. The apparatus of claim 2, wherein:
the essentially horizontal cushioned surface is the top surface of the furniture;

4. The apparatus of claim 3, wherein:
at least one edge of the one or more elevated surfaces is raised for preventing a person's heel from moving horizontally;

5. The apparatus of claim 4, wherein:
a portion of the raised surface supported by the floor supported structure is narrower than the elevated surface for providing a clearance under the raised edge thereby exposing an additional essentially horizontal surface area;

6. The apparatus of claim 5, wherein:
a height of the one or more elevated surfaces is adjustable relative to the elevation of the essentially horizontal surface of the floor supported structure.

7. The apparatus of claim 6, wherein:
a stop for positioning the one or more elevated surfaces horizontally with respect to an edge of the floor supported structure.

8. A method of use of an apparatus that supports both heels of a user's crossed legs for preventing contact between the user's crossed legs, comprising the steps:
a. Supplying a apparatus of claim 7;
b. Locating the apparatus on a floor supported structure with a stop pressed against a edge of the floor supported structure;
c. Sitting or reclining with a legs placed on either side of the apparatus;
d. Placing a heel of a lower leg on an essentially horizontal surface of the floor supported structure;
e. Placing a upper leg in crossed position over the lower leg;
f. Lowering the heel of the upper leg onto the elevated surface;
g. Sliding the heel of the upper leg against a raised edge of the elevated surface;
h. Adjusting the elevation of the apparatus for establishing an approximately half inch space between the upper leg and the lower leg;
